(19) United States
(12) Patent Application Publication
(10) Pub. No.: US 2004/0093990 A1
(43) Pub. Date: May 20, 2004

(54) Sprocket/socket wrench with mechanically-linked co-rotating turning heads

(76) Inventor: Mel Wojtynek, Carlsbad, CA (US)

Correspondence Address: FUESS & DAVIDENAS, Suite II-G, 10951 Sorrento Valley Road, San Diego, CA, 92121-1613, US

(21) Appl. No.: 10/300,054

(22) Filed: Nov. 19, 2002

(51) Int. Cl. B25B 17/00

(52) U.S. Cl. 81/57.3

(57) ABSTRACT

A double-ended ratchet, or socket, wrench with (1) an elongate body has (2) a rotatable turning head at each end of the elongate body, and (3) a mechanism within the body for mechanically linking rotation of each turning head to the other. Each, and either, turning head may be (2a) a cylindrical body typically with a square or twelve-point interior aperture, or (2b) a square spindle, each presenting at its exterior surface (2c) sprocket teeth. The (3) rotational linkage mechanism can be any of (3a) a continuous loop chain, (3b) a train of intermeshing gears, or (3b) a drive shaft, each engaging the exterior surface (2c) sprocket teeth of each (2) turning head so as to link rotation of each (2) turning head to the other. In use one end of the tool is directly or indirectly mounted to an object that is desired to be rotated and/or torqued, normally in tight confines. The body of the tool then extending into a more accessible area, permissively strong rotational motion and torquing forces are applied to the turning head at the other end of the tool, including most commonly by use of an external socket wrench, and are transmitted along the length of the tool to the confined turning head, rotating the confined object.

### BACKGROUND OF THE INVENTION

1. Field of the Invention

The present invention generally concerns a hand tool for imparting rotational and torquing forces; particularly a hand tool for delivering into a workpiece, especially in a confined space, rotational and torquing forces about a drive axis that is spaced-parallel to, but separated at some distance from, a driven axis where rotational motion and torque forces developed externally to the tool are received into the tool.

The present invention particularly concerns a hand tool for offsetting (1) externally-developed rotary motion, and torque forces, received into a proximal-end turning head of the tool, into (2) corresponding rotary motion, and torque forces, at (2a) a distal-end turning head of the tool, and about (2b) another, drive, axis that is parallel to the driven axis, but displaced from it.

2. Description of the Prior Art

2.1 The Basic Ratchet Wrench

U.S. Pat. No. 2,500,835 to J. W. Lang for a RATCHET WRENCH shows the basic form of the tool that is improved by the present invention.

2.2 Rachet Wrenches Where Something is Moved Along the Axis of the Handle to Rotate a Sprocket or Spindle

There is a class of rachet wrenches where something is moved along the axis of the handle of the wrench in order to rotate a sprocket or spindle.

U.S. Pat. No. 2,288,217 to Trautman for a DOUBLE RATCHET WRENCH shows a ratchet wrench where turning of a sprocket gear may be realized by longitudinal telescoping movement of a handle connected to the sprocket gear by a link chain, as well as by a normal pivoting movement of the tool handle.

U.S. Pat. No. 2,530,553 to Strobel for a CHAIN DRIVEN RATCHET WRENCH shows a ratchet wrench where turning of a sprocket is realized by rotation of an internal loop chain in response to a reciprocating movement of a shuttle that is built into the handle of the wrench.

U.S. Pat. No. 3,447,404 to Christian for a HIGH SPEED RATCHET WRENCH concerns a ratchet wrench where a spindle affixed to an internal drum is turned by action of pulling longitudinally in the direction of the handle a cord that is wrapped about the drum. Operation is in the manner of spinning a toy top.

U.S. Pat. No. 4,224,844 to Henriksen for a RATCHET BOLT DRIVE APPARATUS INCORPORATING BIDIRECTIONALLY OPERABLE RECIPROCATING DRIVE MEANS concerns a ratchet drive mechanism for rotating a bolt in response to both (1) torque that is applied to a handle, and (2) a bidirectionally-operable reciprocating means. The handle supports a drive chain which rotates around a pair of sprockets. A push rod supports a lock means which engages the chain. The lock means hooks against the chain, permitting the chain to be pushed and pulled on alternate strokes. The chain is thus rotated around the sprockets, one of the sprockets being an idler and one of the sprockets being mounted on the exterior of the drive of the mechanism. When low torque is required, the push rod can be reciprocated. When high torque is required, the handle can be pivoted.

U.S. Pat. No. 4,507,989 to Baker for a RATCHET TOOL concerns a ratchet tool comprises a tubular body with a handle at one end and a ratchet drive at the other end. The handle mounts a lever mechanism which is operatively connected to the ratchet drive by a plunger, a gear mechanism and a flexible member. When the lever mechanism is operated linear movement of the plunger translates through the gear mechanism and the flexible member into rotary motion of the ratchet drive. With the lever mechanism removed the ratchet tool can be used as a conventional ratchet.

2.3 Rachet Wrenches Having Plier-like Handles That are Squeezed to Rotate a Sprocket or Spindle

There is another class of rachet wrenches having pliers-like handles that are squeezed or otherwise moved in order to rotate a sprocket or spindle.

U.S. Pat. No. 3,286,560 to Murray for a RATCHET WRENCH shows a pliers-type wrench where turning of a spindle is realized by squeezing of a pliers-type handle about a pivot so as to rotate a turning head having the form of an apertured cylinder or a square spindle.

U.S. Pat. No. 3,447,404 to LaChance for a SOCKET WRENCH WITH LEVER OPERATED PAWL MEANS AND A THRUST BLOCK FOR SAID PAWL MEANS shows a wrench with a single handle pivoting against a thrust block so as to, by action of a linkage including a pawl, rotate a distal-end socket. The pivot axis of the handle is thus removed in a proximal direction from the distal-end socket, and from the workpiece.

U.S. Pat. No. 3,941,017 to Lenker, et al. for a PLIER TYPE RATCHET WRENCH concerns a plier-type ratchet wrench of simple, economical and robust construction employing (1) a single rigid thrust rod or bar to operate the ratchet drive, and (2) a single extensible helical spring which both biases the operating handle to its normal position and keeps the thrust rod and a pawl engaged with the ratchet.

2.4 A Combination Reciprocating and Squeezing Handle to a Ratchet Wrench

U.S. Pat. No. 4,656,894 to Goetz for a RATCHET WRENCH concerns a ratchet wrench having a chain drive and three separate operating handles that permit the wrench to be operated in three different modes providing various degrees of torque and various speed ratios.

### SUMMARY OF THE INVENTION

The present invention contemplates a common ratchet wrench, such as is the subject of U.S. Pat. No. 2,500,835, expanded and adapted to include (1) a chain, (2) a series of gears, (3) a drive shaft, or still other drive mechanism between the two turning heads—each typically in the form of a sprocket or a spindle or a socket—located one at each end of the ratchet wrench. Although the rachet wrench can be operated conventionally, rotary motion and torque forces delivered into either turning head of the tool—such as may typically arise from coupling the one turning head to a separate and external socket wrench—are transmitted to, and replicated at, the other turning head of the tool. The tool thus translates rotational movements and torque forces about a proximal-end, driven, axis into like rotational movements and torque forces about a distal-end, driving, axis. In so doing it operates to displace strong rotary forces in a manner substantially dissimilar to all other tools known to the inventor.

1. Operation and Purpose of the Tool of the Present Invention

The drive mechanism of the tool of the present invention functions to make that whenever rotation, and torque, is applied to a sprocket, square spindle, or socket at either end of the tool will cause a sprocket, square spindle, or socket at the other end of the tool to co-rotate in lock step.

Although the elongate body of the tool can undergo conventional pivoting and arcing motion from either end in order to turn in a ratcheting action a sprocket, square spindle or socket at the other end of the tool, in its most preferred operation an externally-derived rotational movement, and torquing force, are delivered into the tool. This rotational movement, and torquing force, may be so externally derived by, for example, a separate socket wrench.

This externally-derived rotational movement, and torquing force, is delivered into a sprocket or socket at one—either—end of the tool, and about a first axis, now defined as “driven” axis, that is substantially perpendicular to the axis of the tool. This external rotational movement and torquing force is commonly developed by a common hand-, electric-, or air-powered socket or torque wrench, and may be very strong.

This motion and this force as received into the turning head at one end of the tool is transmitted by a drive mechanism down the length of the tool and into the turning head at the other end of the tool. This second turning head—again in the form of a sprocket, a square spindle or a socket—engages a workpiece, now along a second axis, now defined as the “driving” axis, that is again substantially perpendicular to the tool. The rotational motion, and the torque torquing force, delivered about the “driving” axis serve to rotate and to torque the workpiece.

The first, “driven”, axis is thus spaced parallel to the second, “driving”, axis. The entire tool can thus be perceived as a force displacement mechanism. Namely, (1) potentially strong rotational and torque forces delivered into the tool at a first-location turning head and about a first, driven, axis into (2) equivalent rotational and torque forces delivered by the tool into a workpiece at a displaced, second, location and about a spaced-parallel second, driving, axis.

The purpose for mechanically linking the rotation of the turning heads at each end of the tool is simple. A distal-end turning head may be placed—including placement by use of an intermediary adapter such as a common socket—over the head of a bolt or like fastener that is located in extremely tight quarters, and at a location where normal direct access for turning the bolt or like fastener is effectively impossible. The body of the sprocket/socket tool in accordance with the present invention will then extend transversely from this distal-end turning head, positioning the proximal-end turning head into a region of greater accessibility. This proximal-end turning head is then suitably engaged by some external tool, such as a common hand or power socket wrench, so as to cause it to rotate. The induced rotation, and torque forces, thus imparted to the proximal-end turning head are transmitted by the mechanical mechanism down the body of the sprocket/socket tool and into the distal-end turning head, serving to rotate this distal-end turning head and the bolt or fastener.

A number of sprocket/socket tools in accordance with the present invention may even be combined in a “daisy chain” to deliver rotational motion and strong torquing forces around corners and the like. The sprocket/socket tool may be built in a “bent”, ar “arched”, version so that the body of the tool is not in a straight line between the torquing heads at each end of the tool. The sprocket/socket tool may and also, and independently, be built in an “offset” version so that rotational motions and torquing forces at each end of the tool are delivered each in a separate plane spaced-parallel to the other.

Each of the two turning heads of the tool can preferably serve at any one particular time as either that head which is imparting torquing force to an object outside the tool (the “driving” turning head), or that head which is receiving rotational motion and torquing force from outside the tool (the “driven” turning head).

Each of the two turning heads is extremely versatile in form. Each may especially from time to time, and at times, fit adapters that variously support both driving, and being driven. The most preferred turning heads are susceptible both to receive, and/or to produce, rotary motion and torquing forces from either side of the turning head and/or the sprocket/socket tool.

The tool may in any case be both (1) turned over (i.e., rotated 180° about its central axis) or (2) flipped end for end (i.e., rotated 180° in any plane about its center point).

A sprocket/socket wrench tool in accordance with the present invention may always be used, and may be used wheresoever located in any position along a daisy chain (insofar as external clearances locally so permit), in the manner of a normal and conventional pivoting and ratcheting ratchet, or socket, wrench. However, a great strength of the sprocket/socket wrench tool of the present invention that users soon come to experience the tool primarily as a means for communicating and transposing rotary motion and torquing forces in a manner quite separate and apart from the ratchet tools of the prior art (which the new tool of the present invention only superficially resembles). Users usually soon forgo any attempts at all to pivot the body of the tool of the present invention once it is positioned, and instead typically prefer simply to plug a conventional socket wrench or driver tool into the accessible second-end turning head, thereafter quickly and easily performing all manipulations from this offset location.

In particular, both light and strong torque forces may be imparted to and through the sprocket/socket tool of the present invention; the second end of the tool where the tool user applies rotational motions and forces giving through the force-transmitting mechanism of the tool substantially the same “feel” of the bolt or other fastener being torqued as if this bolt or fastener was being conventionally directly manipulated. The tool of the present invention is thus “transparent” in use, and the user need not struggle to learn and to calibrate motions and forces applied by use of the tool, but will feel these motions and forces in and as, most commonly, the completely normal and conventional motions and forces felt from use of the external socket wrench.

2. A Ratcheting Sprocket/Socket Wrench

Accordingly, in one of its aspects the present invention is embodied in an elongate body having a rotatable turning head at each end of the elongate body, with a mechanism within the body mechanically linking rotation of each turning head to the other.

Each turning head may be a partially hollow cylindrical body presenting at its exterior surface sprocket teeth. The hollow of the cylindrical body can be, by way of example, (1) a square aperture as will fit a square spindle, or (2) a “twelve-point”, “six-point”, or other aperture as fits over the head of a hexagonal bolt of nut. Each turning head may alternatively be a substantially solid cylindrical body still presenting at its exterior surface gear teeth. In this case one, or both, sides of the solid-cylinder turning head typically presents a square spindle.

The mechanical mechanism within the body of the tool may be a continuous loop chain engaging the exterior surface sprocket teeth of the cylindrical body of each turning head so as to link rotation of each turning head to the other.

Either, or both, turning heads can optionally engage within the body of the tool a spring-loaded dog which permits rotation within but a single direction. The tool is then turned over to permit rotation in opposite directions. Because each turning head is rotationally linked to the other, it is clear that each spring-loaded dog must permit rotation in the same direction. The question might thus be raised: why bother with two? One answer is that a local anti-rotation dog can help absorb strong torque forces otherwise transmitted to the other end of the tool.

Likewise, either, or both, turning heads can optionally engage a sliding mechanism that locks all rotation. Again, since rotation of each turning head is linked to the other, the primary use of a sliding mechanism at both heads is to locally absorb such strong torque forces as must otherwise be transmitted to the other end of the tool.

The mechanical mechanism between the turning heads may alternatively be a line, or train, of gears intermeshing one to the next from the exterior surface gear teeth of one turning head to the exterior surface gear teeth of the other, this line of gears serving to mechanically link rotation of each turning head to the other.

The mechanical mechanism may still further alternatively be a shaft having affixed at each end a bevel gear; the bevel gear at each end of the shaft intermeshing with the beveled gear teeth of the cylindrical body of one of the turning heads.

Returning to the turning heads, these are substantially independent of the mechanical mechanism within the wrench by which rotational motion, and torque, is coupled between them. Regardless of the contours of its exterior circumference, the cylindrical body of each turning head may separately and independently assume diverse forms. For example, each and either cylindrical body may be in the form of a hollow cylinder with teeth suitable to engage a rotatable hexagonal fitting upon its interior circumferential surface. Per dictionary definition, such a body is called a “cylindrical sprocket”. It is manifestly suitable to engage at its interior circumference the hexagonal head of, by way of example, a bolt. A turning head so configured is thus suitable to rotate the bolt when the remaining turning head—to which it is mechanically linked by the chain, gear or shaft mechanism—is itself rotated.

Each and either cylindrical body may further alternatively be in the form of a solid cylinder, normally with a square spindle protruding to one or to both sides of the body. A tool so configured assumes the external form of a one, or two-, headed socket wrench. A turning head so configured is manifestly suitable to couple and to turn a common socket when it is itself rotated by the remaining turning head—to which it is mechanically linked by the chain, gear or shaft mechanism.

Each and either cylindrical body may still further alternatively be in the form of a hollow cylinder with a central opening suitable to engage a square spindle, ergo a cylindrical sprocket suitable to engage at its central opening the square spindle of, by way of example, an external socket wrench. A turning head so configured is manifestly suitable to be rotated by a socket wrench—thus rotating also the remaining turning head to which it is mechanically linked by the chain, gear or shaft mechanism.

A number of such rachet wrenches in accordance with the present invention may be mechanically linked at their rotating heads one rachet wrench to the next in the manner of a daisy chain. The wrenches within the daisy chain need not be identical, nor identically coupled one to the next. The multiple-wrench daisy chain not only permits displacement of rotational motion, and toque forces, over a greater distance, but permits these motions and forces to be communicated along, and across, very convolute three-dimensional paths.

3. A Tool for Transmitting Rotary Motion and Torque Forces Across a Distance

In another of its aspects the present invention is embodied in a tool for transmitting rotary motion and torque forces across a distance.

The tool includes (i) an elongate body with a central axis, (ii) an externally-driven first rotatable head at one end of the elongate body accepting rotary motion and torque forces external to the tool along a driven axis that is perpendicular to the central axis, (iii) an externally-driving second rotatable head at the other end of the elongate body producing rotary motion and torque forces external to the tool along a drive axis that is both perpendicular to the central axis and spaced parallel to the driven axis by a distance of separation of the first and the second rotatable heads, and (iv) a mechanism within the body mechanically linking rotation of the externally-driven first rotatable head to the externally-driving second rotatable head. By this construction, and this coaction, rotary motion and torque forces are delivered from the driven axis, perpendicular to the central axis at the first rotatable head, to the driving axis, perpendicular to the central axis at the second rotatable head and spaced parallel to the driven axis.

The first rotatable head and the second rotatable head may be connected by a chain drive, a gear drive, or a shaft drive.

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 is a perspective view of a first embodiment of a sprocket/socket wrench in accordance with the present invention.

FIG. 2 is a cut-away plan view of the first embodiment of a sprocket/socket wrench in accordance with the present invention previously seen in FIG. 1 taken along aspect line 2-2, the cutaway view showing the chain drive of the wrench.

FIG. 3 is a perspective view of a second embodiment of a sprocket/socket wrench in accordance with the present invention.

FIG. 4 is a cut-away plan view of the second embodiment of a sprocket/socket wrench in accordance with the present invention previously seen in FIG. 3 taken along aspect line 3-3, the cutaway view showing the gear drive of the wrench.

FIG. 5 is a perspective view of a third embodiment of a sprocket/socket wrench in accordance with the present invention.

FIG. 6 is a cut-away plan view of the third embodiment of a sprocket/socket wrench in accordance with the present invention previously seen in FIG. 5 taken along aspect line 4-, the cutaway view showing the shaft drive of the wrench.

### DESCRIPTION OF THE PREFERRED EMBODIMENT

The following description is of the best mode presently contemplated for the carrying out of the invention. This description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

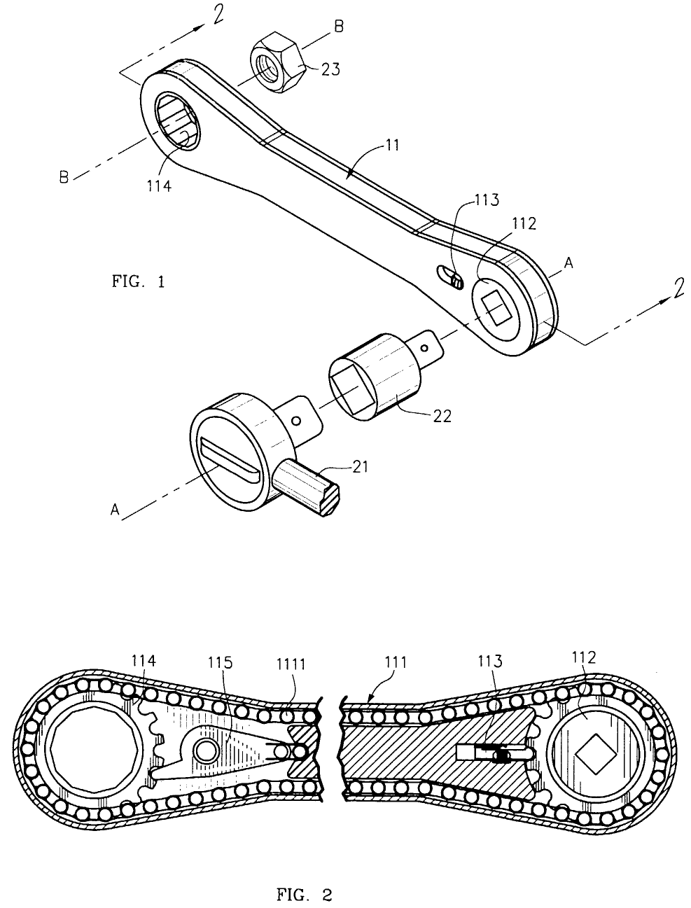

Three preferred embodiments of sprocket/socket tools 11, 12 and 13 in accordance with the present invention are respectively shown in perspective view in FIGS. 1, 3 and 5, and in x-ray plan view in FIGS. 2, 4 and 6. All tools 11, 12, 13 appear substantially identical to the exterior; visual differences between the tools being mostly dependent upon different configurations of sprocket and socket driving heads at each end of the tools 11, 12, 13. However, the various configurations of the driving heads can be fitted to any embodiment, the particular driving heads configurations shown in the drawings for each embodiment of the tools 11, 12 and 13 being exemplary only.

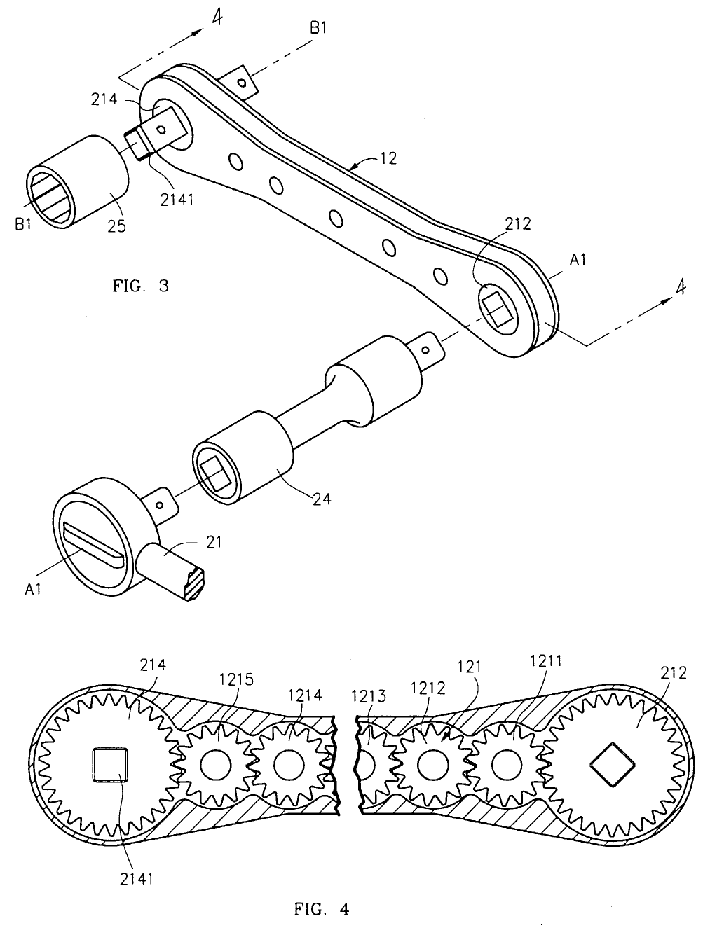

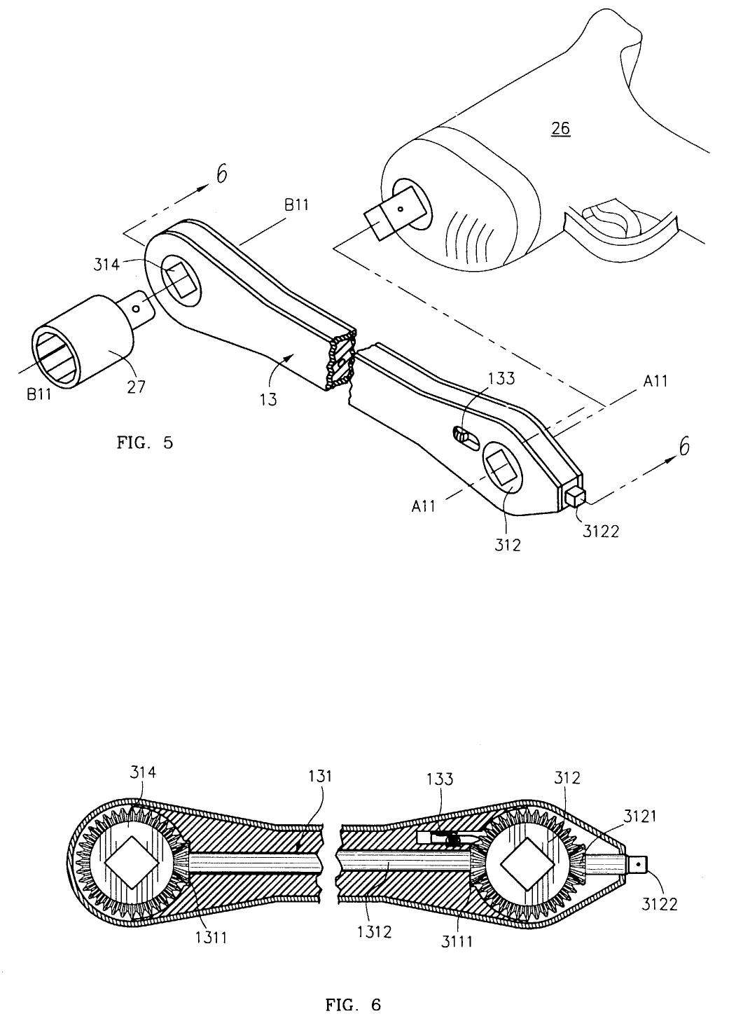

The first embodiment of the sprocket/socket tool 11 shown in FIGS. 1 and 2 is called the chain drive embodiment after its chain drive 111 prominently visible in the cut-away view of FIG. 2. The second embodiment of the sprocket/socket tool 12 shown in FIGS. 3 and 4 is called the gear drive embodiment after its gear drive 121 prominently visible in the cut-away view of FIG. 4. The third embodiment of the sprocket/socket tool 13 shown in FIGS. 5 and 6 is called the shaft drive embodiment after its shaft drive 131 prominently visible in the cut-away view of FIG. 6.

In each embodiment the chain drive 111, the gear drive 121 or the shaft drive 131 serves to translate rotary motion, and torquing forces, delivered into the tool 11, 12, 13 at an arbitrarily selected first-end driving head into corresponding rotary motion, and torque forces, at the tools second-end driving head.

For example, in the first embodiment of the tool 11 shown in FIGS. 1 and 2, rotary motion and torquing forces are delivered into the tool 11 at a first-end turning head that consists of square-aperture sprocket sleeve 112 from a socket wrench 21 acting through an adapter 22 (shown in exploded view, and also in phantom line for not being part of the present invention). Note that this rotary motion, and this torquing force, is delivered about an axis A-A that is substantially perpendicular to both the elongate axis 2-2 of the tool, and the plane of the sprocket sleeve 112. With the sprocket sleeve detente 112 in the withdrawn position—oppositely to the position shown in FIGS. 1 and 2—rotary motion of the sprocket sleeve 112 in either rotational directional sense is translated into rotary motion of the closed-loop chain 1111 of the chain drive 111, and causes lock-step rotation of the second-end turning head consisting of sprocket sleeve 114. This sprocket sleeve 114 has, by way of an example, an internal twelve-point aperture suitable to engage, for example, a nut 23 (shown in phantom line for not being part of the present invention). Note also that this rotary motion, and this torquing force, is delivered along an axis B-B that is again substantially perpendicular to both the elongate axis 2-2 of the tool, and to the plane of the sprocket sleeve 114. The drive axis B-B is, as illustrated, spaced parallel to the driven axis A-A.

In detail of construction for the tool 11, the chain 1111 is normally made of steel links complimentary in size and spacing to external sprocket teeth on the exterior circumferences of each of the sprocket sleeves 112, 114. The chain 1111 is constrained to run in a track formed by the body of the tool 1, which body is normally stamped in two or more pieces. If desired, the body can be made wider in its central regions so as to reduce any tendency of strong forces on the chain to bow outward the shell of the body. In accordance that the chain 1111 and sprocket sleeves 112, 114 are preferably hardened steel, with the body of the tool 11 closely confining all, the chain 1111 and/or the exterior teeth of the sprocket sleeves 112, 114 are hard to break, and even a small chain of thickness ¼ inch (0.5 centimeter) may typically transmit hundreds of foot pounds (scores of kilogram meters) of torque. This is substantially independent of the length of the tool. The tool 11 can be broken, but is not normally subject to break in normal use, meaning use proportional to the reasonable torque forces applied to rotary fasteners subject to being engaged by the tool 11, or to forces reasonably applied to the tool 11 by external socket wrench 21 and the like of size corresponding to the tool 11.

Further in detail of construction for the tool 11, a sliding detente 113 permits locking the rotation of all parts: sprocket sleeves 112, 114 and chain 1111. A spring-loaded dog 115 engages the exterior teeth of the sprocket sleeve 114, permitting such rotation in only one direction as provides for a ratcheting action. (This ratcheting action is independent of, and in addition to, any ratcheting action that may be exhibited by an external rachet tool such as, inter alia, the socket wrench 21.) According to this unidirectional rotation, the tool 11 is turned over to effect ratcheting rotation in each—a clockwise and a counterclockwise—direction.

Note that the spring-loaded dog 115 permitting rotation within but a single direction could be duplicated at each end of the tool 11. Because each turning head sleeve 112, 114 is rotationally linked to the other by chain 1111, it is clear that two spring-loaded dogs must each permit rotation in the same direction. The reason to even bother with two is that a local anti-rotation dog can help absorb strong torque forces otherwise transmitted to the other end of the tool. Likewise, the sliding detente 113 that locks all rotation could be duplicated at both turning head sleeves 112 (where presently illustrated) and 114 so as to best locally absorb such strong torque forces as must otherwise be transmitted to the other end of the tool.

Similarly, in the second embodiment of the tool 12 shown in FIGS. 3 and 4, rotary motion and torquing forces are delivered into the tool 12 at a first-end turning head again consisting of square-aperture sprocket sleeve 212, and again from a socket wrench 21 acting through a long adapter 24 (shown in exploded view, and also in phantom line for not being part of the present invention). Note that this rotary motion, and this torquing force, is delivered about an axis A′-A′ that is substantially perpendicular to both the elongate axis 4-4 of the tool, and the plane of the sprocket sleeve 212. Rotary motion of the sprocket sleeve 212 in either rotational directional sense is translated into rotary motion of the gears 1211-1215 of the gear drive 121, and causes lock-step rotation of the second-end turning head consisting of sprocket spindle 214. This sprocket spindle 214 has, by way of an example, a square spindle 2141, illustrated extending in two directions along axis B′-B′ but optionally extending on only one direction—suitable to engage, for example, a socket 23 (shown in phantom line for not being part of the present invention). Note yet again that this rotary motion, and this torquing force, is delivered along an axis B′-B″ that is again substantially perpendicular to both the elongate axis 2-2 of the tool, and to the plane of the sprocket spindle 214. The drive axis B′-B′ is, as illustrated, spaced parallel to the driven axis A′-A′.

In detail of construction for the tool 12, the intermeshing gears 1211-1215—which may vary in size and number—are normally made of hardened steel, as are the sprocket sleeve 212 and the sprocket spindle 214, each of which mounts complimentary gear teeth on it external circumference. The intermeshing gears 1211-1215 may vary in size and number, and whether the number of gears is odd or even will influence whether the clockwise or counterclockwise rotational sense at the driven sprocket sleeve 21 is the same, or reversed, from the clockwise or counterclockwise rotational sense at the driving sprocket spindle 214.

As was the chain drive 111 in the tool 11 of FIGS. 1 and 2, the gear drive 121 of the tool 12 of FIGS. 3 and 4 is retained tightly within the housing of the tool 12. The center posts of the gears 1211-1215 are preferably steel rivets also used to join a preferred two halves of the housing. All in all, the gears 1211-1215, the sprocket sleeve 212, and the sprocket spindle 214 are all strongly maintained in position, and are hard to break or dislodge. The second embodiment of the tool 12, which can be constructed relatively inexpensively using in some cases stock gears, is perhaps the strongest of the three embodiments.

A third exemplary embodiment of the tool 13 in accordance with the present invention is shown in FIGS. 5 and 6. This embodiment, which employs a shaft drive 131, is often built at relatively longer lengths than the first embodiment tool 11 of FIGS. 1 and 2, and the second embodiment tool 12 of FIGS. 3 and 4, because the shaft drive, although potentially neither as strong nor as permanently aligned as is the chain drive 111 or the gear drive 121 (respectively shown in FIGS. 2 and 4)., is relatively lightweight.

In a manner that should by now be familiar, rotary motion and torquing forces are delivered into the tool 13 at a first-end turning head yet again consisting of square-aperture sprocket sleeve 213. This time the forces are delivered from a power driver tool 26 (shown in phantom line for not being part of the invention), and from an opposite side of the tool 13 to the driven element of pluggable socket 27 (also shown in phantom line for not being part of the invention). Note that the sprocket sleeves 312, 314 at each end of the tool 13 have the same internal form—a square aperture. Usually one only is, however, checked in rotation by a spring-loaded dog 133 (seen in FIG. 6) so as to permissively undergo ratcheting rotation in one only directional sense.

Note in FIG. 4 that the exterior circumference of the sprocket sleeves 312, 314 preferably presents a complex contour. The external circumference is notched, as in a gear, while a bevel gear surface, normally oriented at 45°, is also presented to, and intermeshed with, a conical-contour bevel gear head 1311 at each end of the shaft 1312.

The third embodiment of the present invention in tool 13 presents an opportunity to import along yet another axis—this time coaxial with the axis of the tool along aspect line 6-6, such rotational movement, and torque forces, into the tool 13 as do cause rotational movement, and torquing forces, of its sprocket sleeves 312, 314. This may be realized by auxiliary drive head 3122, which most commonly couples a socket drive. Rotational motion and toque forces provided at this auxiliary drive head 3122 are transmitted down a stub shaft and into a bevel gear to drive the same sprocket sleeve 312 that is otherwise driven in rotation by the power diver tool 26, or equivalent, about the axis A11-A11. As illustrated, this smaller auxiliary drive head 3122 may be, by way of example, a ¼″ drive while the main drive is ⅜″ or even ½″, making that this auxiliary drive head is most commonly used for speeding rotation of the sprocket sleeves 312, 314 under light torque forces, with high-torque forces being otherwise realized.

The bevel, spur and ring gear components, and force transmission through these components, is challenging unless careful attention in paid to establishing and maintaining alignments and, insofar as is possible, broad, strong and substantial areas of contact. In this area a practitioner of the mechanical arts must use his or her intelligence and experience as to how to do things commensurate with the magnitude of the torque forces that are desired to be transmitted.

In the first place, the shaft 1312 can be held firmly within a corresponding central bore of the body of the tool 13, which body can be, it can be imagined, thinner than illustrated in FIGS. 5 and 6. Next, the conical gear head 1311 can be much larger—but this serves to thicken at least the driving head regions of the tool 13. Next, each bevel gear head 1312 can be built in two identical tapered halves which, when reversed one upon another and fastened strongly together, provide that the corresponding bevel gear head 1311 of the shaft drive 131 is captured between them.

In this manner, and others within the ability of a practitioner of the mechanical arts, the shaft drive 131 can be made alternatively, and stronger, than it appears in FIGS. 5 and 6 if so desired. Nonetheless to this possibility, and nonetheless that the construction of the shaft drive is again economical, the shaft drive is not preferred overall for tools that are placed in service with amateur mechanics because, when constructed at normal sizes from conventional steels, the shaft drive tool 13 can usually be stressed to failure at extreme high torque loads. The most common failure mode is a stripping of the bevel gears 312, 1311, but if these are very strong (at commensurate cost) and the shaft very long, then it is possible to torsion the shaft 1312.

A number of rachet wrenches in accordance with the present invention may be mechanically linked at their rotating heads one rachet wrench to the next in the manner of a daisy chain. It is trivial to envision a straight extension of plural wrenches, and only slightly harder to envision that each wrench may be canted at virtual any angle −170° to +170° to the previous wrench in line. It is accordingly well within the ability of a craftsman or mechanic to figure out how to “gang” wrenches—possibly with adapters even two different wrenches of a same “set”—so as to transmit rotational motion, and torque forces, around a corner.

Choice of linkage components becomes a bit more “tricky” when three dimensions are involved. However, problems in imparting rotary motion at points, and along axis, displaced in three dimensions are also soluble by use of multiple “daisy-chained” tools of the present invention (with necessary socket drive extension pieces). Construction of these sometimes arcane combinations is left to the imagination of the reader; a good practice problem being to figure out in theory how to remove the lug nuts from the wheel of a 4-wheel vehicle from a position outside the diagonally opposite wheel.

In accordance with the preceding explanation, variations and adaptations of the ratchet and socket wrenches in accordance with the present invention will suggest themselves to a practitioner of the mechanical and/or tool arts. For example, a great number of driving heads of diverse individual, and joint, configuration are clearly possible. This is why the tool of the present invention is suitably spoken of as a sprocket wrench, or as a socket wrench: merely adapting spindles and sockets—instead of sprockets—to the driving heads can may the tool of the present invention into something that is arguably as close to a double ended socket wrench, or, alternatively, a socket wrench with a drive input at the end of its handle, as a modified sprocket wrench.

For example, the tools 12, 13 of the present invention can be built with an offset at one or both ends by making the gear drive (of the tool 12) or the shaft drive (of the tool 13) to be multi-segment.

Finally, and by momentary reference to FIG. 6, it takes but little imagination to contemplate that the first-end sprocket sleeve 312 should be discarded, and that the driven end of the shaft 1312 should end butt-on in square spindle, or the like, that might be engaged by a socket wrench or the like so as to be rotated. For that matter, the first-end sprocket sleeve 312 may be maintained in place, and a new bevel gear 3121 connected to a stub drive shaft 3122 located at the proximal end of the tool 13.

The prior art to the present invention shows that infinite variations like these are, if not trivial, well within the scope of the present intention. Therefore, in accordance with these and other possible variations and adaptations of the present invention, the scope of the invention should be determined in accordance with the following claims, only, and not solely in accordance with that embodiment within which the invention has been taught.

What is claimed is:

1. A ratchet wrench comprising:
a elongate body:
a rotatable turning head at each end of the elongate body; and
a mechanism within the body for mechanically linking rotation of each turning head to the other.

2. The ratchet wrench according to claim 1 wherein each turning head comprises:
a cylindrical body presenting at its exterior surface sprocket teeth;
and wherein the mechanism comprises:
a continuous loop chain engaging the exterior surface sprocket teeth of the cylindrical body of each turning head so as to link rotation of each turning head to the other.

3. The ratchet wrench according to claim 2 wherein the cylindrical body of at least one turning head comprises:
a hollow cylinder with teeth suitable to engage a rotatable hexagonal fitting upon its interior circumferential surface, ergo a cylindrical sprocket suitable to engage at its interior circumference a bolt;
wherein the at least one turning head so configured is suitable to rotate the bolt when the remaining turning head to which it is mechanically linked by the chain mechanism is itself rotated.

4. The ratchet wrench according to claim 2 wherein the cylindrical body of at least one turning head comprises:
a hollow cylinder with a central opening suitable to engage a square spindle, ergo a cylindrical sprocket suitable to engage at its central opening a spindle of a socket wrench;
wherein the at least one turning head so configured is suitable to be rotated by a socket wrench, thus rotating also the remaining turning head to which it is mechanically linked by the chain mechanism.

5. The ratchet wrench according to claim 1 wherein each turning head comprises:
a cylindrical body presenting at its exterior surface gear teeth;
and wherein the mechanism comprises:
a line, or train, of gears intermeshing one to the next from the exterior surface gear teeth of one turning head to the exterior surface gear teeth of the other, the line of gears serving to mechanically link rotation of each turning head to the other.

6. The ratchet wrench according to claim 5 wherein the cylindrical body of at least one turning head comprises:
a hollow cylinder with teeth suitable to engage a rotatable hexagonal fitting upon its interior circumferential surface, ergo a cylindrical sprocket suitable to engage at its interior circumference a bolt;
wherein the at least one turning head so configured is suitable to rotate the bolt when the remaining turning head to which it is mechanically linked by the gear mechanism is itself rotated.

7. The ratchet wrench according to claim 5 wherein the cylindrical body of at least one turning head comprises:
a hollow cylinder with a central opening suitable to engage a square spindle, ergo a cylindrical sprocket suitable to engage at its central opening a spindle of a socket wrench;
wherein the at least one turning head so configured is suitable to be rotated by a socket wrench, thus rotating also the remaining turning head to which it is mechanically linked by the gear mechanism.

8. The ratchet wrench according to claim 1 wherein each turning head comprises:
a cylindrical body presenting at its exterior surface beveled gear teeth;
and wherein the mechanism comprises:
a shaft; having affixed at each end
a bevel gear, the bevel gear at each end intermeshing with the beveled gear teeth of the cylindrical body of one of the turning heads.

9. The ratchet wrench according to claim 8 wherein the cylindrical body of at least one turning head comprises:
a hollow cylinder with teeth suitable to engage a rotatable hexagonal fitting upon its interior circumferential surface, ergo a cylindrical sprocket suitable to engage at its interior circumference a bolt;
wherein the at least one turning head so configured is suitable to rotate the bolt when the remaining turning head to which it is mechanically linked by the shaft mechanism is itself rotated.

10. The ratchet wrench according to claim 8 wherein the cylindrical body of at least one turning head comprises:
a hollow cylinder with a central opening suitable to engage a square spindle, ergo a cylindrical sprocket suitable to engage at its central opening a spindle of a socket wrench;
wherein the at least one turning head so configured is suitable to be rotated by a socket wrench, thus rotating also the remaining turning head to which it is mechanically linked by the shaft mechanism.

11. A connected succession of two or more rachet wrenches in accordance with claim 1 mechanically linked at their rotating heads one rachet wrench to the next.

12. A tool for transmitting rotary motion and torque forces across a distance, the tool comprising:
an elongate body with a central axis;
an externally-driven first rotatable head at one end of the elongate body accepting rotary motion and torque forces external to the tool along a driven axis that is perpendicular to the central axis;
an externally-driving second rotatable head at the other end of the elongate body producing rotary motion and torque forces external to the tool along a drive axis that is both perpendicular to the central axis and spaced parallel to the driven axis by a distance of separation of the first and the second rotatable heads; and
a mechanism within the body mechanically linking rotation of the externally-driven first rotatable head to the externally-driving second rotatable head;
wherein rotary motion and torque forces are delivered from the driven axis, perpendicular to the central axis at the first rotatable head, to the driving axis, perpendicular to the central axis at the second rotatable head and spaced parallel to the driven axis.

13. The according to claim 12 wherein the mechanism comprises:
a chain drive between the first rotatable head and the second rotatable head.

14. The according to claim 12 wherein the mechanism comprises:
a gear drive between the first rotatable head and the second rotatable head.

15. The according to claim 12 wherein the mechanism comprises: a shaft drive between the first rotatable head and the second rotatable head.
